(19) United States
(12) Patent Application Publication
(10) Pub. No.: US 2010/0038921 A1
(43) Pub. Date: Feb. 18, 2010

(54) Doorstop

(75) Inventors: Trevor Alan Kirkham, Las Vegas, NV (US); Collin Mark Schneider, Las Vegas, NV (US)

Correspondence Address: Goff Patent Law PLLC, P.O. Box 625, Brush Prairie, WA, 98606, US

(73) Assignee: TACC INNOVATIONS, LLC, Las Vegas, NV (US)

(21) Appl. No.: 12/191,945

(22) Filed: Aug. 14, 2008

(51) Int. Cl. E05C 17/54

(52) U.S. Cl. 292/343

(57) ABSTRACT

A doorstop can include a support area resting on a door hinge joint, a flared portion extending forward from the support area, and an engaging portion extending down from the support area. The flared portion can abut one or both of a first hinge leaf and a door, and one or both of a second hinge leaf and a doorjamb. The engaging portion can engage the hinge and tend to prevent the doorstop from being forced out of position as the door attempts to close. The doorstop can be balanced about the support area.

### TECHNICAL FIELD

The description relates generally to doorstops, and more particularly to doorstops that can be placed on door hinges to hold doors open.

### BACKGROUND

For many years, doorstops have been used to hold doors open. Perhaps the most common type of doorstop has been a simple wedge that is placed between a door and a floor surface to keep a door open. Wedge doorstops have been made of many different kinds of materials, such as wood and polymers. While such doorstops may be sufficient for some purposes, they have significant drawbacks. For example, they require a user to reach down to the floor and place the doorstop under the door to hold the door open, and require a user to reach down to the floor and remove the doorstop to allow the door to close again. This can be inconvenient for many users, especially when they need to place and remove the doorstop while they are carrying items.

Because of these drawbacks of standard wedge doorstops, others have come up with doorstop designs that are secured to or hang from a door hinge. Two examples are described in U.S. Patent Publication No. 20060032017 by Agster et al. and U.S. Patent Publication No. 20070261207 to Ranilovich. The Agster et al. doorstop is made of a hard rubber or synthetic polymer material that defines a receiving channel between a block member and a securing member. A user places downward pressure on the doorstop to force it down into a position where the receiving channel engages a hinge pin and hinge plates of a door hinge.

The Ranilovich doorstop is made of a nylon or polymer material and includes a substantially cylindrically shaped seating portion for releasably securing over a top edge of a hinge sleeve. The doorstop also includes an outwardly flared portion that extends integrally from the seating portion to abut a doorjamb and a door, thereby holding the door open.

### SUMMARY

Whatever the advantages of previous doorstops, they have neither recognized the doorstop features described and claimed herein, nor the advantages produced by such features. For example, the present inventors have discovered that it is advantageous for a doorstop with an outwardly flared portion to be balanced about a support area of a doorstop that can rest on top of a door hinge joint. Such a design can allow for a doorstop that is effective, easy to use, and/or easy for a user to carry when the doorstop is not being used.

According to one embodiment, a doorstop can include a support area that is able to rest on a door hinge pin, an engaging portion extending back and down from the support area, and a flared portion flaring outward as it extends forward from the support area. The doorstop can be balanced about the support area.

According to another embodiment, a door hinge can include a first hinge leaf secured to a door, a second hinge leaf secured to a doorjamb, and a hinge joint pivotally joining the first and second hinge leaves. A doorstop can include a support area resting on the hinge joint, a flared portion extending forward from the support area, and an engaging portion extending down from the support area. The flared portion can abut one or both of the first hinge leaf and the door, and one or both of the second hinge leaf and the doorjamb. The engaging portion can engage the hinge and tend to prevent the doorstop from being forced out of position as the door attempts to close. The doorstop can also be balanced about the support area.

According to yet another embodiment, a doorstop can include means for supporting the doorstop on a joint of a door hinge that pivotally connects a door and a doorjamb. The doorstop can also include means for pressing against the door and the doorjamb, the means for pressing extending forward from the means for supporting. Additionally, the doorstop can include means for engaging the joint of the door hinge to tend to keep the doorstop from moving forward due to forces on the doorstop from the door and the doorjamb. The doorstop can have a center of gravity located under the means for supporting.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a front lower perspective view of a door holding apparatus before a doorstop is placed to hold a door open.

FIG. 2 is a front lower perspective view of the door holding apparatus of FIG. 1 with a doorstop positioned to hold the door open.

FIG. 3 is a right side lower perspective view of an embodiment of a doorstop.

FIG. 4 is a front lower perspective view of the doorstop of FIG. 3.

FIG. 5 is a bottom view of the doorstop of FIG. 3.

FIG. 6 is a top view of the doorstop of FIG. 3.

FIG. 7 is a right side view of the doorstop of FIG. 3.

FIG. 8 is a left side view of the doorstop of FIG. 3.

FIG. 9 is a front view of the doorstop of FIG. 3.

FIG. 10 is a rear view of the doorstop of FIG. 3.

FIG. 11 is a right side lower perspective view of an alternative embodiment of a doorstop.

The description and drawings may refer to the same or similar features in different drawings with the same reference numbers.

### DETAILED DESCRIPTION

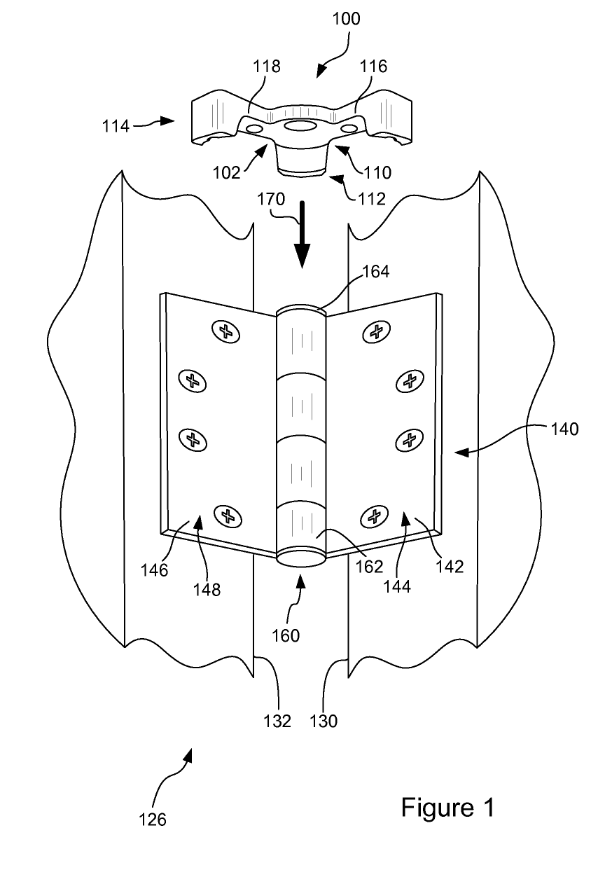

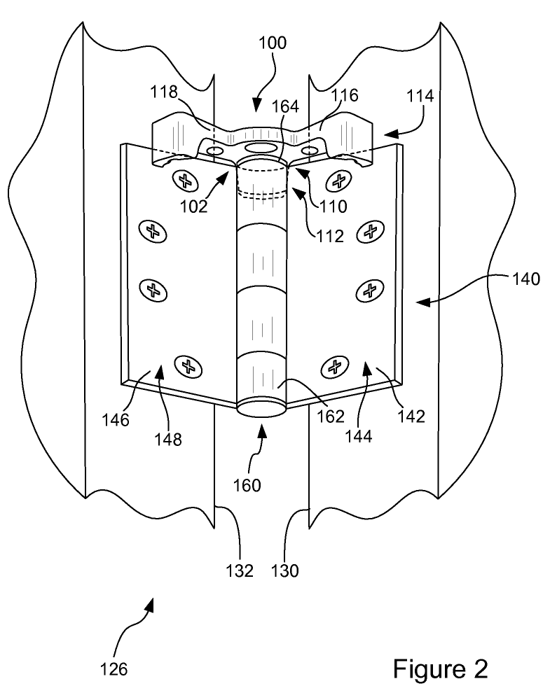

Referring to FIGS. 1-2, a doorstop (100) can be a substantially Y-shaped flat planar body that includes a hub (102) defining a generally planar support area (110). An engaging portion (112) can extend rearward and down from the support area (110). A flared portion (114) can extend forward from the hub (102) in a general V shape, which can include a right leg (116) and a left leg (118).

Referring still to FIGS. 1-2, a door holding apparatus (126) can include the doorstop (100), as well as a doorjamb (130) and a door (132). FIGS. 1-2 illustrate the doorjamb (130) on the right and the door (132) on the left, but they can be arranged in the opposite positions. The door (132) can be rotatably secured to the doorjamb (130) by a door hinge (140). The door hinge (140) can include a right leaf (142) secured to the doorjamb (130) with right leaf fasteners (144), such as standard screws. The door hinge (140) can also include a left leaf (146) secured to the door (132) with left leaf fasteners (148), such as standard screws. The right and left leaves (142 and 146) can be rotatably joined by a joint (160), which can include a sleeve (162) surrounding a hinge pin (164). Thus, the hinge (140) can rotatably secure the door (132) to the doorjamb (130), possibly with the help of other hinges above or below the hinge (140). The hinge (140) can be a standard door hinge, such as a typical metal door hinge. Other configurations are also possible. For example, some doors are secured to other doors so that they can open in an accordion fashion. In such situations, one door section may act as a doorjamb for an adjacent door section.

Still referring to FIGS. 1-2, the doorstop (100) can be moved in a generally downward direction (170) onto the hinge (140) to separate the door (132) and the doorjamb (130), to hold the door (132) open. The support area (110) can rest on the top of the hinge joint (160), such as on top of the head of the hinge pin (164), to support the doorstop (100). The engaging portion (112) can extend down behind the hinge joint (160), and the flared portion (114) can extend forward from the hinge joint (160). Thus, the right leg (116) can abut the right leaf (142) and/or the doorjamb (130) and the left leaf can abut the left leaf (146) and/or the door (132). Accordingly, the flared portion (114) can press on the door (132) and the doorjamb (130), either directly or via one or both leaves (142 and 146) to hold the door (132) open. This tends to prevent the door (132) from moving toward the doorjamb (130) and closing. For a typical door that automatically closes, the door will constantly apply an inward pressure on the flared portion (114) of the doorstop (100), which will bias the doorstop (100) forward. However, that forward biasing pressure can be opposed by the contact between the engaging portion (112) and the back side of the door hinge joint (160) so that the doorstop (100) remains in place even when the door (132) is biased toward a closed position.

The doorstop (100) can be balanced about the support area (110), meaning that a center of gravity of the doorstop (100) can be located over, under, or at the support area (110) that can rest on the hinge joint (160). Thus, even if there is no force biasing the door (132) toward a closed position, such as when the door (132) gets bumped toward an open position during use, the doorstop (100) can remain in its operable position illustrated in FIG. 2. Indeed, the doorstop (100) can remain in its operable position even without the doorstop (100) being secured to the hinge (140) with an interference fit or in some other manner.

This arrangement produces substantial benefits that are not present in or predictable from prior doorstops. For example, the doorstop (100) can stay in its operable position without the need to be secured to the hinge, such as with an interference fit with the hinge (140) or a large hook or other securing member applying pressure to the hinge to keep the doorstop (100) in its operable position. Accordingly, the doorstop (100) can be substantially planar and flat because it does not need a hook or other securing device to apply constant securing pressure to the hinge (140). Also, the doorstop (100) can be made of a rigid material, such as metal, because the doorstop (100) does not need to flex to form a securing interference fit with the hinge (140) during use.

The substantially flat planar profile of the doorstop (100) can be advantageous because it can allow a user to easily slide the doorstop (100) in and out of his/her pocket during use. For example, this can be advantageous for a waiter or waitresses, a bellhop, or even a firefighter, who could conveniently keep a doorstop (100) in his/her pocket and easily slide the doorstop (100) out of the pocket when it is needed to hold a door open.

Moreover, the use of strong rigid material, such as aluminum or other metals, can be advantageous because they resist flexing when additional pressure is applied to the door (132), such as when the door (132) gets bumped toward the closed position. Such bumping can cause doorstops made of flexible materials to flex, and sometimes even shoot out of the operable position when a door is bumped.

The subject matter defined in the appended claims is not necessarily limited to the benefits described herein. Rather, a particular implementation of the invention may provide all, some, or none of the benefits described herein.

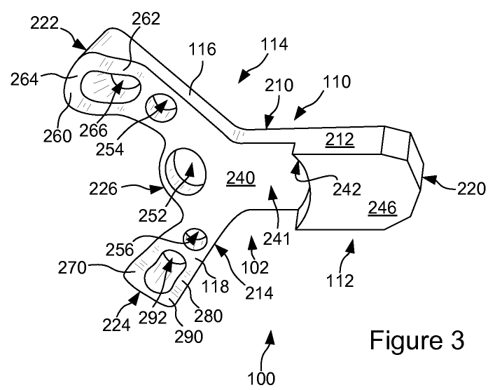

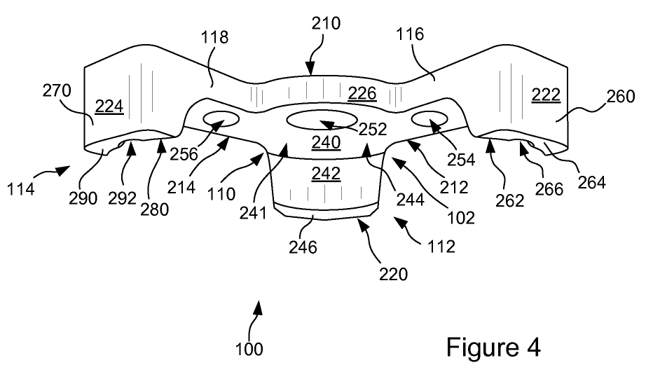

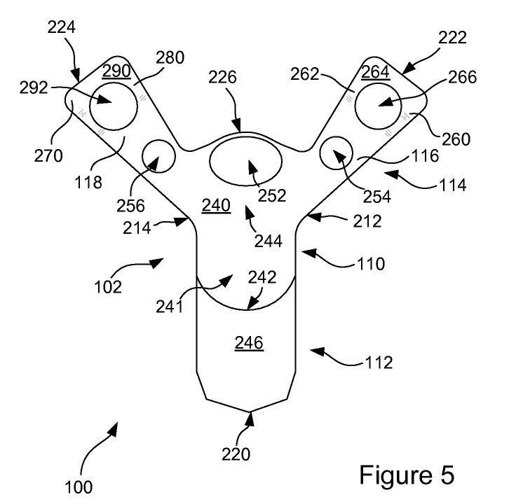

Referring now to FIGS. 3-10 and describing the doorstop (100) in more detail, the doorstop (100) can have a substantially planar top surface (210). As noted above, the doorstop (100) can have an overall Y-shaped profile, and the top surface (210) can have that same overall shape. A generally vertical right side surface (212) can extend along the right sides of the right leg (116), the hub (102), and the engaging portion (112) to define a right side of the doorstop (100). Similarly, a generally vertical left side surface (214) can extend along the left sides of the left leg (118), the hub (102), and the engaging portion (112) to define a left side of the doorstop (100).

A convex rear vertical surface (220), formed by four substantially planar surfaces at obtuse angles to each other, can extend around the rear of the engaging portion (112). A convex curved vertical right leg end surface (222) can extend around the front of the right leg (116), and a convex curved vertical left leg end surface (224) can extend around the front of the left leg (118). A vertical front surface (226) can extend in a curved, generally W-shaped, pattern along the left side of the right leg (116), along the front of the hub (102), and along the right side of the left leg (118).

A horizontal planar support surface (240) can extend along a bottom side of the hub (102) and forward along the bottom of the legs (116 and 118), defining a top of a centrally located support recess (241) defined by the legs (116 and 118) and the hub (102). The support recess (241) can be large enough to allow a top of a door hinge joint (160) to fit up into the recess (241) without forming an interference fit (although an interference fit could be formed in some embodiments). A concave vertical engaging surface (242) can extend down from a rear periphery of the support surface (240) to form a front surface of the engaging portion (112) of the doorstop (100), and to define a rear border of the support recess (241).

A generally planar horizontal engaging portion bottom surface (246) can define a bottom of the engaging portion (112) and extend between the bottom edges of the side surfaces (212 and 214), the rear surface (220), and the concave engaging surface (242). The support surface (240) can define a bottom of the hub (102) and the rear portions of the legs (116 and 118). The hub (102) can define a centrally and forward located hub hole (252) that can be positioned forward on the support surface (240). Additionally, the right leg (116) can define a vertically-extending right leg hole (254) and the left leg (118) can define a vertically-extending left leg hole (256).

The right leg (116) can include a right foot (260) extending down from a front end of the right leg (116). A right foot rear surface (262) can slope down from the support surface (240) to define a rear surface of the right foot (260), and a right foot bottom surface (264) can extend forward from the bottom of the rear surface (262) to form a bottom surface of the right foot (260). Also, a right foot hole (266) can extend vertically through the right foot (260).

The left leg (118) can include a left foot (270) extending down from a front end of the left leg (118). A left foot rear surface (280) can slope down from the support surface (240) to define a rear surface of the left foot (270). A left foot bottom surface (290) can extend forward from the left foot rear surface (280) to form a bottom surface of the left foot (270). Also, a left foot hole (292) can extend vertically through the left foot (270).

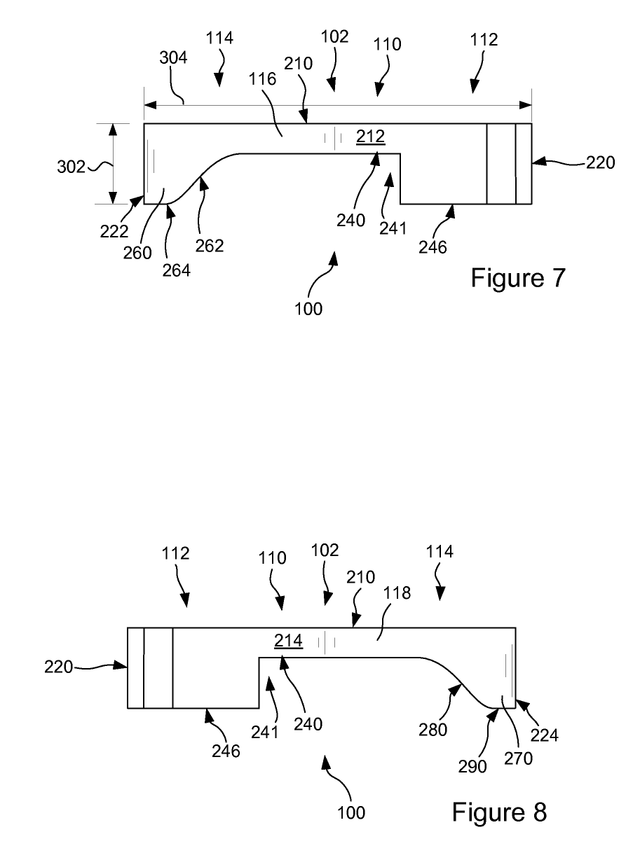

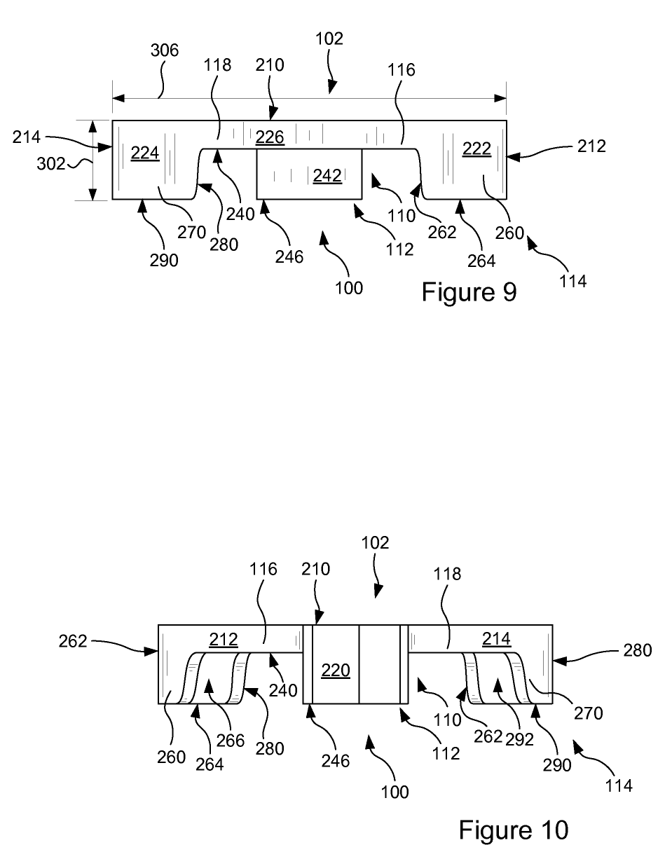

The engaging portion bottom surface (246), the right foot bottom surface (264), and the left foot bottom surface (290) can all be substantially coplanar in a bottom plane that is substantially parallel to the top surface (210) (see FIGS. 7-10). A height (302, see FIGS. 7 and 9) between the top surface (210) and the bottom plane that includes the bottom surfaces (246, 264, and 290) can be less than about 0.75 inch, and it can be about 0.5 inch or even less than that in some embodiments. In one embodiment, the doorstop (100) can have a forward-to-rear length (304, see FIG. 7) of about 2.7 inches and a width (306, see FIG. 9) of about 2.75 inches. Thus, a length-to-height ratio of the doorstop (100) can be greater than about 3.6, or from about 3.6 (with a height of about 0.75 inch) to about 5.4 (with a height of about 0.5 inch), and a width-to-height ratio of the doorstop (100) can be greater than about 3.7, or from about 3.7 (with a height of about 0.75 inch) to about 5.5 (with a height of about 0.5 inch). Accordingly, the overall doorstop (100) can have a generally flat planar profile that makes it easy to handle and to store when it is not being used.

Many different dimensions and shapes are possible for a doorstop according to the present invention. However, in one embodiment, the height (302) of the doorstop can be about 0.5 inch, the length (304) of the doorstop can be about 2.7 inches, the width (306) of the doorstop can be about 2.75 inches, the leg holes (254 and 256) can each have a diameter of about 0.26 inch, the foot holes (266 and 292) can each have a diameter of about 0.37 inch, the hub hole (252) can be an oval with a width (side-to-side) of about 0.685 inch and a length (front-to-back) of about 0.483 inch, the engaging portion (112) can have a width (side-to-side) of about 0.74 inch, and the engaging surface (242) can extend up about 0.32 inch to meet the support surface (240).

The surfaces of the doorstop (100) can be continuous, or they can have defined vertices, edges or other borders between or even within them. For example, the concave surfaces or convex surfaces could be continuous (as with the front surface (226)) or they could be formed by a series of planar surfaces arranged in generally concave or convex patterns (as with the rear surface (220)). As another example, the entire doorstop could be formed by continuous curved surfaces with virtually no defined edges between them.

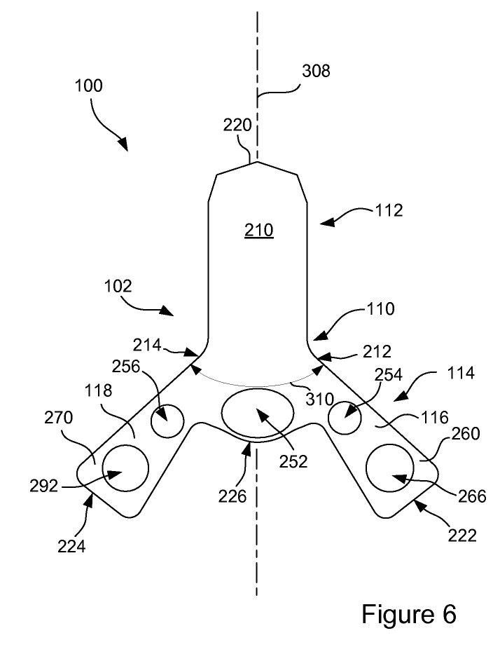

The holes (252, 254, 256, 266, and 292) assist in balancing the doorstop (100) from front to back by decreasing the mass of the doorstop (100) forward of the support area (110). However, the doorstop could be otherwise balanced by altering the shape, dimensions and/or materials of one or more portions of the doorstop (100) to adjust the weight forward of the support area (110) or rearward of the support area (110). For example, the doorstop could be balanced from front to back by being symmetrical from front to back. This could be done by having a back flared portion that is identical to a front flared portion (with both flared portions being similar to the flared portion (114) shown in FIGS. 1-11), as well as having an engaging portion extending down on the front and an identical engaging portion extending down on the back (with both engaging portions being similar to the engaging portion (112) shown in FIGS. 1-11). Thus, in such an embodiment, the doorstop would have a general X shape, rather than the general Y shape of the doorstop (100) shown in FIGS. 1-11. The doorstop (100) can be symmetrical about a longitudinal axis (308) (see FIG. 6) to provide balance from right to left, or the doorstop (100) can be otherwise designed to provide right-to-left balance. Many other changes in the design of the doorstop could also be implemented, although the embodiments illustrated in FIGS. 1-11 can provide particularly ornamental appearances.

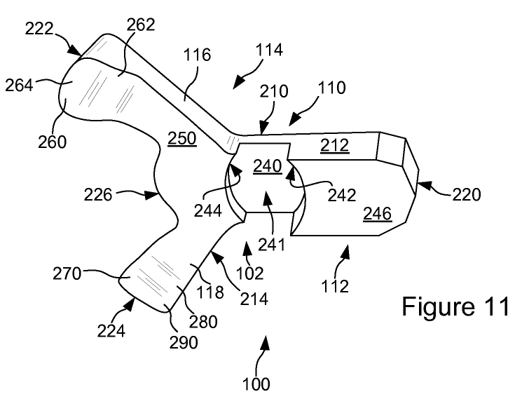

FIG. 11 illustrates just one of the many possible alternative doorstop embodiments. The doorstop (100) of FIG. 11 is similar to (and has the same reference numbers for corresponding similar features) the embodiment of FIGS. 3-10. However, the FIG. 11 doorstop can be formed with no through holes. In addition, a front concave support defining surface (244) can extend down from a front periphery of the support surface (240) to form a front border of the support recess (241) opposite the engaging surface (242). A generally W-shaped hub-and-leg surface (250) can extend forward from a bottom of the front support defining surface (244) and along a bottom of the hub (102) and the legs (116 and 118), to the feet (260 and 270). The front support defining surface (244) typically does not need to extend down as far as the engaging surface (242). This is because the engaging surface (242) can contact the hinge joint (160) during use (see FIG. 2) to prevent the doorstop (100) from moving forward, but the balancing of the doorstop (100) makes it so that the doorstop (100) need not secure the hinge joint by applying pressure between two opposing surfaces (although it could do so in some embodiments).

The doorstop (100) can be held in a person's pocket, and can be easily retrieved for use. Referring back to FIG. 1, in use, the door (132) can be opened so that the hinge (140) forms an angle greater than an angle (310) (see FIG. 6) between the outside surfaces of the legs (116 and 118) of the doorstop (100). The doorstop (100) could be formed with this angle being greater or less, depending on the desired angle between the door (132) and the doorjamb (130) when the doorstop (100) is holding the door (132) open.

With the door (132) in this open position illustrated in FIG. 1, the doorstop (100) can be placed on the hinge (140) in the operational position illustrated in FIG. 2. In this position, the doorjamb (130) and/or right leaf (142) of the hinge (140) can press on the portion of the right side surface (212, referenced in FIGS. 3-10) that extends along the right leg (116), and the door (132) can press on the portion of the left side surface (214, referenced in FIGS. 3-10) that extends along the left leg (118). This pressing biases the doorstop (100) forward, but the doorstop (100) is prevented from moving forward by the contact between the back side of the hinge joint (160) and the engaging surface (242, referenced in FIGS. 3-10) of the engaging portion (112). Thus, as discussed above, the doorstop (100) can hold the door (132) in the open position illustrated in FIGS. 1-2. The doorstop (100) can be removed by simply moving the engaging portion (112) up and bringing the doorstop (100) forward away from the hinge (140). This allows the door (132) to close. The doorstop (100) can then be placed in a person's pocket or some other appropriate place until it is used again.

The generally planar shape can be advantageous for manufacturing because, for example, it can simplify manufacturing if the doorstop (100) is machined from a flat sheet of material. However, the surfaces could have convex and/or convex curvatures instead of, or as part of, the overall flat planar shape. The doorstop (100) can be manufactured from an aluminum sheet, such as an aluminum sheet that is about 0.5 inch thick. The aluminum can be 6061 t-6 aluminum, some other aluminum alloy from the 6061 family of alloys, or some other metal or other material. The doorstop (100) can be cut and shaped using a conventional CNC mill programmed using standard CAD/CAM software. Alternatively, the doorstop (100) can be formed using some other type of manufacturing process(es) and/or some other type of material(s). For example, the doorstop (100) could be formed by molding a high strength rigid polymer material, such as a fiber reinforced plastic material.

While the invention has been particularly shown and described with reference to preferred embodiments thereof, it will be understood by those skilled in the art that various changes in form and details may be made therein without departing from the spirit and scope of the invention. For example, the doorstop could form some other shape, such as a T shape, rather than a Y Shape, or the flared portion could be filled in so that the flared portion forms a delta shape. As another example, the engaging portion could engage back sides of the leaves of the hinge instead of, or in addition to, engaging the back side of the hinge joint. As yet another example, the legs could be a constant thickness so that there would be no feet extending down at the ends of the legs.

I claim:

1. A doorstop comprising:
a support area that is able to rest on a door hinge pin;
an engaging portion extending back and down from the support area; and
a flared portion, the flared portion flaring outward as it extends forward from the support area;
wherein the doorstop is balanced about the support area.

2. The doorstop of claim 1, wherein a center of gravity of the doorstop is under the support area.

3. The doorstop of claim 1, wherein the support area, the engaging portion, and the flared portion are all part of a substantially flat body.

4. The doorstop of claim 1, wherein the doorstop defines a recess that is configured to receive the door hinge pin.

5. The doorstop of claim 14, wherein the support area defines a substantially planar support surface.

6. The doorstop of claim 1, wherein the doorstop is comprised of metal.

7. The doorstop of claim 6, wherein the metal comprises aluminum.

8. The doorstop of claim 1, wherein the flared portion comprises a pair of legs angling out from the support area.

9. The doorstop of claim 1, wherein a height of the doorstop is about 0.75 inch or less.

10. The doorstop of claim 9, wherein the height of the doorstop is about 0.5 inch or less.

11. An apparatus comprising:
a door hinge comprising:
a first hinge leaf secured to a door;
a second hinge leaf secured to a doorjamb; and
a hinge joint pivotally joining the first and second hinge leaves;
a doorstop comprising:
a support area resting on the hinge joint;
a flared portion extending forward from the support area, the flared portion abutting one or both of the first hinge leaf and the door, and the flared portion also abutting one or both of the second hinge leaf and the doorjamb; and
an engaging portion extending down from the support area, the engaging portion engaging the hinge and tending to prevent the doorstop from being forced out of position if the door attempts to close;
the doorstop being balanced about the support area.

12. The doorstop of claim 11, wherein a center of gravity of the doorstop is within the hinge joint.

13. The doorstop of claim 11, wherein the engaging portion engages the hinge joint.

14. The doorstop of claim 11, wherein the flared portion abuts the first hinge leaf and the second hinge leaf.

15. The doorstop of claim 11, wherein the flared portion comprises:
a first abutting surface that abuts the first hinge leaf and the door; and
a second abutting surface that abuts the second hinge leaf and the doorjamb.

16. The doorstop of claim 11, wherein a height of the doorstop is about 0.5 inch or less.

17. A doorstop comprising:
means for supporting the doorstop on a joint of a door hinge that pivotally connects a door and a doorjamb;
means for pressing against the door and the doorjamb, the means for pressing extending forward from the means for supporting; and
means for engaging the joint of the door hinge to tend to keep the doorstop from moving forward due to forces on the doorstop from the door and the doorjamb;
the doorstop having a center of gravity located under the means for supporting.

18. The doorstop of claim 17, wherein the means for supporting, means for pressing, and means for engaging are all part of a substantially flat body.

19. The doorstop of claim 17, wherein the means for engaging extends rearward and down from the means for supporting.

20. The doorstop of claim 19, wherein the means for pressing comprises a flared member that flares out as it extends forward from the means for supporting.
